(19) United States
(12) Patent Application Publication
(10) Pub. No.: US 2015/0112778 A1
(43) Pub. Date: Apr. 23, 2015

(54) OFFER SHARING

(71) Applicant: MICROSOFT CORPORATION, Redmond, WA (US)

(72) Inventors: BORIS FELDMAN, SEATTLE, WA (US); JOSE SAURA, REDMOND, WA (US); GENE MICHAEL DECLARK, KIRKLAND, WA (US)

(73) Assignee: MICROSOFT CORPORATION, Redmond, WA (US)

(21) Appl. No.: 14/059,754

(22) Filed: Oct. 22, 2013

(51) Int. Cl. G06Q 30/02

(52) U.S. Cl. CPC G06Q 30/0214; G06Q 30/0269
USPC 705/14.16; 705/14.66

(57) ABSTRACT

Aspects of the present invention describe an offer service that incentivizes people to share offer invitations with other people. An offer invitation gives a person an opportunity to subscribe to a customized offer with an incentive (e.g., a discount on a good or service) provided by a vendor. The offer invitation can take many forms. In one aspect, the offer invitation is a digital communication (e.g., a text, email, social post) that provides some details and provides a means to subscribe to the offer. The offer invitation can be passed between users that each receives a different offer upon subscribing to the offer. A user may receive a different sharing incentive based on the sharing mechanism he uses to share a user invitation. For example, a user may receive a larger incentive when he shares an offer invitation through his social network than when he shares via email.

### BACKGROUND

Advertisements may take the form of coupons or discount offers mailed, emailed, downloaded, or otherwise communicated to a user. A coupon provides a discount on the listed price of a good or service. The coupon may be provided by a manufacturer, a vendor, or in cooperation with each other. Users may share coupons or offers with friends, for example by forwarding an email.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Aspects of the present invention describe an offer service that incentivizes people to share offer invitations with other people. An offer invitation gives a recipient an opportunity to subscribe to a customized offer that comprises an incentive (e.g., a discount on a good or service) to purchase a good or service. In one aspect, the offer is a card-linked offer. The offer invitation can take many forms. In one aspect, the offer invitation is a digital communication (e.g., a text, email, social post) that provides some details and provides a means to subscribe to the offer. The offer invitation can be passed between users that each receives a different customized offer upon responding to the invitation. The offer invitation may provide an overview generally explaining an offer that may be available to a user.

An offer invitation may be communicated through one or more of the user's social networks. For example, users could post an offer to their Facebook page. Users could also communicate an offer through private messaging options available in their social network.

A user may receive a different incentive based on the sharing mechanism he uses to share an offer invitation. For example, a user may receive a larger incentive when he shares an offer invitation through his social network than when he shares via email. Different incentives may be given for sharing in different social networks. For example, a larger incentive may be given for sharing via Facebook than through Twitter.

### BRIEF DESCRIPTION OF THE DRAWINGS

Aspects of the invention are described in detail below with reference to the attached drawing figures, wherein:

FIG. 1 is a block diagram of an exemplary computing environment suitable for implementing aspects of the invention;

FIG. 2 is a diagram of an advertising environment suitable for card-linked offers, in accordance with an aspect of the present invention;

FIG. 3 is a diagram illustrating a sharing incentive and customized offers, in accordance with an aspect of the present invention;

FIG. 4 is a diagram showing a nonlinear offer path, in accordance with an aspect of the present invention;

FIG. 5 is a diagram showing a linear offer path, in accordance with an aspect of the present invention;

FIG. 6 is a sequence diagram illustrating communications occurring when a customized offer is communicated from one user to another, in accordance with an aspect of the present invention;

FIG. 7 is a flow chart showing a method of providing customized offers, in accordance with an aspect of the present invention; and

FIG. 8 is a flow chart showing a method of providing customized card-linked offers, in accordance with an aspect of the present invention.

### DETAILED DESCRIPTION

The subject matter of aspects of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Aspects of the present invention describe an offer service that incentivizes people to share offer invitations with other people. An offer invitation gives a recipient an opportunity to subscribe to a customized offer that comprises an incentive (e.g., a discount on a good or service) to purchase a good or service. In one aspect, the offer is a card-linked offer.

As used herein, an “offer invitation” gives a recipient an opportunity to receive a customized offer. The offer invitation is not an offer. Instead, the offer invitation may be used to receive details about a customized offer and subscribe to the offer, if desired. The offer comprises an incentive to try a good or service. The offer may also comprise parameters (e.g., a time and place) for using the offer. Offers are specific to a given person and are not transferable, while offer invitations are freely transferable. In one aspect, an offer invitation will only result in the user receiving an offer when the user meets eligibility requirements for the offer.

The offer invitation can take many forms. In one aspect, the offer invitation is a digital communication (e.g., a text, email, social post) that provides some details and provides a means to respond to the invitation. The offer invitation can be passed between users that each receives a different offer upon responding the invitation. The offer invitation may explain possible incentives and indicate that a specific merchant is willing to extend an offer to qualified individuals. The offer invitation may be solely for the purpose of extending an offer invitation or may serve multiple purposes. The offer service may provide an interface through which the offer invitation may be sent by first user to a second user.

The offer invitation may take the form of an offer notification. An offer notification explains the details of an offer to which a user has subscribed. The offer notification may also include an explanation of incentives for communicating the offer notification to another party and instructions for the receiving party to follow if he wishes to subscribe to the offer or receive an explanation of customized incentives available to him The offer notification becomes an offer invitation when the user communicates the offer notification to another party. Thus, the offer notification can serve as both a notification and an invitation.

An offer invitation may be communicated through one or more of the user's social networks. For example, a user could post an offer to his Facebook page. A user could also communicate an offer through private messaging options available to his social network. A user may receive a different incentive based on the sharing mechanism he uses to share a user invitation. For example, a user may receive a larger incentive when he shares an offer invitation through his social network than when he shares via email. Different incentives may be given for sharing in different social networks. For example, a larger incentive may be given for sharing via Facebook than via Twitter.

As mentioned, the offer may be a card-linked offer. A card-linked offer is an incentive tied to a user's credit card or other form of electronic payment. The incentive may take the form of a monetary discount, refund, or a non-monetary reward in the form of an electronic currency (e.g., phone minutes, additional data) or other value (e.g., loyalty points). As used herein, the term “credit card” includes all bank cards (e.g., ATM cards), and digital payment methods, such as a near field communication chip and mobile phones. The discount tied to the offer is credited to the user as part of the electronic payment method.

To be eligible to receive offers, a user may opt in or subscribe to the card-linked offer service. The card-linked offer service works on behalf of merchants to promote offers to individual users. A user may choose to link one or more credit cards within the service. The incentive associated with the offer is automatically given to the user when a payment method linked to this service is used to make the purchase.

As mentioned, the offer service provides incentive for users to share an offer invitation with other people. The incentive may take the form of an increased discount on an existing offer. For example, a user may receive an offer for a 20% discount on shoes. Upon communicating an offer invitation for this offer to five other people, the discount is increased to 25%.

Sharing incentives can be based on the actions taken by the recipients of the offer invitation. For example, an additional incentive can be given when recipients view an offer invitation, click on offer invitation, accept the offer invitation, and use the offer associated with the invitation to make a purchase. The increased incentives can include an increased discount on an offer to which the sharing user has already subscribed. The increased incentives could include access to one or more separate offers not presently available to the sharing user.

The offer invitation can include a mechanism for identifying the sharer both to the recipient and to the offer service. For example, the offer invitation can include a link to the offer service that automatically identifies the party that shared the offer invitation. Upon following the link, the recipient may be asked to log in to the offer service or sign up, if not already a member.

As mentioned, an aspect of the present invention provides offers that are customized for individuals and that may only be used by the individual. For example, an offer linked to an individual's credit card may only be realized by using the credit card to purchase the good or service. Accordingly, only those authorized to use the credit card can take advantage of the offer. Multiple users may receive the same discount on a good or service, but each user will have a unique offer that allows the user to realize the discount when making a purchase. In this way, the offers are not directly transferable from user to user. In one aspect, only the offer service is able to extend offers. Instead, the user communicates an offer invitation that gives a recipient potential access to the offer or a similar offer depending whether the recipient meets the merchant's eligibility criteria.

Offers may be customized according to merchant rules that are based on a recipient's characteristics. Relevant recipient characteristics include recipient demographics, recipient purchase history, and recipient interests. In some aspects, the recipient characteristics may prevent the recipient from being eligible for an offer. For example, an offer for a discount at a restaurant may be limited to people living less than a threshold distance from the restaurant. A recipient's purchase history may be used to determine whether an individual is a potentially new customer or returning customer. Returning customers may receive a loyalty incentive, while potentially new customers may receive a different offer with a heightened incentive to become a first-time customer.

A user's history of credit card transactions may be used to determine a user's interests. Utilization of previous offers may also be used to determine a user's interest. A user may provide explicit interests through the preferences established with the offer service. Finally, demographic information derived from the user may be used to determine interest by proxy. A user may be given the chance to opt in or opt out of using demographic information or any other type of information gathered.

A user's social network may be analyzed to determine that the user has an interest in a product or service. When a user indicates appreciation for a particular product or shares that she visited a location, such as a restaurant, this information may be used to determine the user's interests. Expressing interest in a product or service may be a criterion to determine whether a particular user is eligible to subscribe to an offer.

The offer service may provide interfaces for merchants and users. The merchant interface allows the merchant to specify the details of an offer and establish recipient characteristics that are used to extend an offer to a given recipient. The merchant may also specify sharing incentives.

The interface for users allows people to subscribe to the sharing service, accept an offer, view active offers, record interests that assign particular offers to the user, and establish other preferences. The user may be able to explicitly set card-linking preferences through the interfaces provided. The preferences may specify a total number of active offers that may be associated with the user at any one time. The preferences may also specify the types of offers the user is interested in. For example, the user may express a preference for offers related to coffee houses or barbecue restaurants. If the user is in the market for a particular product, the user may indicate this and begin automatically being linked to offers related to that product. For example, the user may indicate that he is in the market for new running shoes. Sporting goods stores and other outlets participating in the offer service will automatically have their offers linked to the user when the offer is relevant to running shoes.

The merchants participating in the offer service are given an opportunity to control the offers through one or more business rules. The merchant may limit the number of offers generated during a specific time period. In one aspect, the merchant is able to specify user characteristics that need to be satisfied before a user is extended an offer. For example, the merchant may want to attract new business and specify that only users that have not utilized an offer for this particular merchant may be linked Credit card history may be analyzed to determine whether the user has done business with a particular merchant.

The business rules may be used to limit the times a particular user is extended an offer. For example, if a user utilizes an offer four times, then a business rule may indicate that the user is no longer eligible for subsequent offers provided by the merchant. The business rule may specify a threshold number of utilizations that are acceptable before the user is no longer extended additional offers. In another aspect, the threshold applies to the number of times the user accepts an offer regardless of whether or not the user utilizes the credit-linked offer.

In one aspect, the accepted offers are limited by duration. For example, 1,000 offers may be authorized by the merchant to remain active for one week. The merchant may reauthorize after a week based on results. As users enter the service and their profiles change, the confidence that a user has an interest in a particular offer may change. For example, the user may be notified of an active offer and ignore it for a week, despite driving by a location where the offer could be utilized. This may indicate that the user is less interested in the offer than other users. After a period of time, the offer may be deactivated or delinked to the user and offered to a different user having a higher confidence factor. The confidence factor may be generated by a statistical analysis of user characteristics and behaviors and indicates a degree of confidence that the user has an interest or is likely to utilize the offer.

A merchant may offer multiple offers simultaneously with different goals. For example, a merchant may specify that certain users who have done business with the merchant previously are eligible for a loyalty offer. The loyalty offer encourages a user who is familiar with the business to return, and perhaps try a related product or service. For example, users who have previously had lunch at a restaurant may receive an offer discounting dinner at the restaurant. The merchant may also specify acquisition offers that are designed to lure new customers. In one aspect, the acquisition offers provide a higher incentive than do loyalty offers.

The offers may be part of an offer path that includes a series of offers with different presentation triggers, content, and incentives. For example, a vendor may provide a first offer to users who have not conducted business with the vendor and a second loyalty offer once the user takes advantage of the first offer and becomes a customer. In one aspect, the user's likelihood to consume the offer is used to select an offer within the path.

In one aspect, frequently utilizing offers causes the user to be extended a subsequent offer having a comparatively lower incentive. For example, the subsequent offer to a user that has utilized several offers for lunch discounts may include a 50 cent discount on a sandwich. A user that has not accepted many lunch offers may be extended an offer having a higher incentive, such as a two dollar discount on the sandwich.

Having briefly described an overview of aspects of the invention, an exemplary operating environment suitable for use in implementing aspects of the invention is described below.

### Exemplary Operating Environment

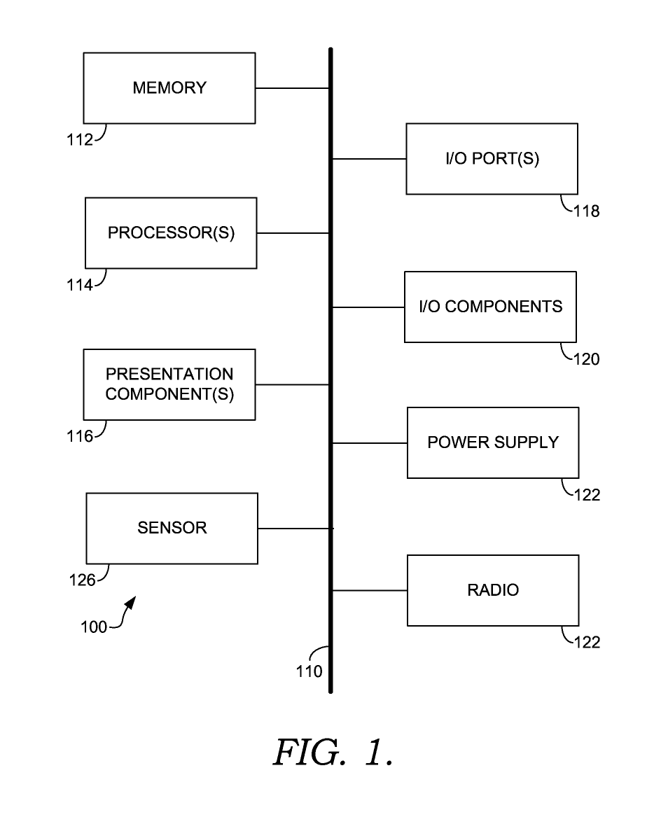

Referring to the drawings in general, and initially to FIG. 1 in particular, an exemplary operating environment for implementing aspects of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the invention may be practiced in a variety of system configurations, including handheld devices, consumer electronics, general-purpose computers, specialty computing devices, etc. Aspects of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component 120. Also, processors have memory. The inventors hereof recognize that such is the nature of the art, and reiterate that the diagram of FIG. 1 is merely illustrative of an exemplary computing device that can be used in connection with one or more aspects of the invention. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory 112 may be removable, nonremovable, or a combination thereof. Exemplary memory includes solid-state memory, hard drives, optical-disc drives, etc. Computing device 100 includes one or more processors 114 that read data from various entities such as bus 110, memory 112 or I/O components 120. Presentation component(s) 116 present data indications to a person or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components 120 include a microphone, joystick, game pad, satellite dish, scanner, printer, wireless device, etc.

### Exemplary Advertising and Content Service

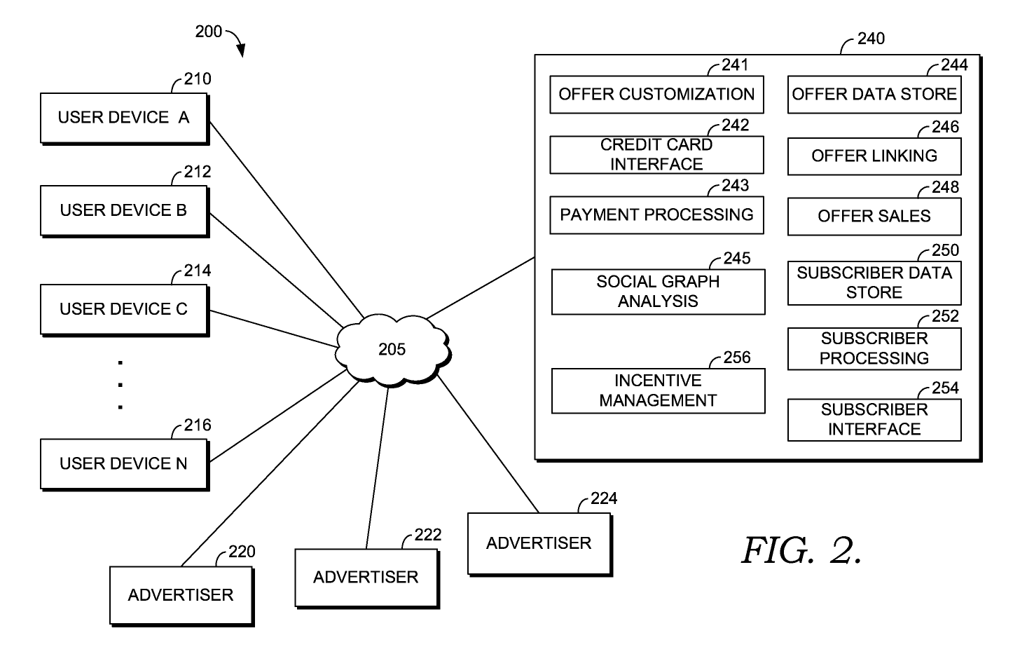

Turning now to FIG. 2, a distributed offer service environment 200 is shown, in accordance with an aspect of the present invention. The environment 200 includes user device A 210, user device B 212, user device C 214, and user device N 216 (hereafter user devices 210-216). User device N 216 is intended to represent that there could be an almost unlimited number of devices connected to network 205. The user devices 210-216 may take different forms. For example, the user devices 210-216 may be game consoles, televisions, DVRs, cable boxes, personal computers, tablets, phones, or other user devices capable of outputting communications.

Network 205 is a wide area network, such as the Internet. Network 205 is connected to advertiser 220, advertiser 222, and advertiser 224. The advertisers 220, 222, and 224 sell products or services associated with offers to linked users of user devices 210-216. The advertisers may also be described as merchants or vendors. The advertisers may have a physical and online presence. In one aspect, the advertiser's offers are only able to be utilized at a physical location, such as a retail store. The advertisers make incentives available to users through the offer service 240. The advertisers may sell the same or similar products or unrelated products.

The offer service 240 may operate in a data store capable of interaction with multiple user devices, credit card companies, and advertisers. The offer service 240 includes an offer customization component 241, a credit card interface 242, a payment processing component 243, a social graph analysis component 245, an offer data store 244, an offer linking component 246, an offer sales component 248, a subscriber data store 250, a subscriber processing component 252, a subscriber interface component 254, and an incentive management component 256.

The offer customization component 241 applies business rules when determining whether an offer should be extended to a user. The business models may define eligibility criteria for one or more offers. Eligibility criteria include user characteristics. Each offer may define a separate product or service and an incentive for a product and service. For example, an offer may be applicable to all running shoes of a certain brand offered by a particular merchant. Exemplary incentives include a 20% discount, buy one get one free, buy one pair one pair 50% off, and the like.

When a user has characteristics that match with an available offer, the offer may be extended to the user. An extended offer, as used herein, is an offer to which the user is able to subscribe. The user may choose not to subscribe, but once extended, the user has a threshold period of time to subscribe. If a user receives an offer invitation from another user and turns out not to be eligible to receive an offer from the associated merchant, then the offer customization component 241 may notify the user. In this situation, the offer customization component 241 may extend a different offer that the user is eligible to receive from a different merchant.

As mentioned, the business rules may specify target audience data for an offer. The business rules may also specify a total number of offers available and circumstances in which an offer is extended and when the offer expires. For example, a user may subscribe to an offer that expires after one week.

The credit card interface 242 is used to instruct credit card companies to apply a discount when card-linked offers are utilized. As mentioned, card-linked offers are a type of offer that may be utilized in aspects of the invention. The credit card interface 242 may also verify the validity of credit card numbers and associate a user with a particular credit card number during user sign-up.

The payment processing component 243 may work with a credit card interface 242 to apply a discount to users. In addition, the payment processing component 243 may capture a portion of a purchase or discount and transfer it to an offer service or brokerage that is associated with the merchant. The payment processing component 243 may send a text or email or other communication confirming that the discount has been applied to the user when an offer is utilized.

The social graph analysis component 245 analyzes the user's social graph. The user's social graph may include relationships in multiple social networks. The social graph analysis component 245 attempts to identify the user's interests and activities. For example, a user's positive comment about a merchant or a product or subject matter may be used to classify the user as interested in that product or subject matter. The social graph analysis component 245 may extract keywords from a user's social posts and use the keywords to identify user interests.

The social graph analysis component 245 may also track recipients of an offer invitation sent within a social network. For example, a user may receive a different incentive based on the amount of people that receive an offer invitation. The social graph analysis component 245 may determine how many individuals received an offer invitation shared by a user. The social graph analysis component 245 may also determine whether an individual viewed an offer invitation, clicked on an offer invitation, or took some other action with respect to an offer invitation. The social graph analysis component 245 may also help the user communicate offer invitations within her social network.

The offer data store 244 stores offers and customized incentives that have been submitted by advertisers. Each offer and incentive may have criteria derived from the business rules. Each offer can include a description and terms and conditions. For example, the amount of the incentive and where the incentive may be realized is explained. In one aspect, the offer includes graphics that may be presented to the user as part of a notification. In one aspect, the offer includes a geo-notification criteria that indicates a geographic area in which an offer notification or reminder should be presented to the user. In addition to location, other presentation criteria may be associated with an offer notification, such as a time period for presenting a notification.

The offer linking component 246 links card-linked offers to a user's account after a user subscribes. The offer linking component 246 may provide a notification upon performing a link. The offer linking component 246 follows business rules and user preferences when linking

The offer sales component 248 provides a portal through which advertisers may define offers. In one aspect, the particular subject matter or interests of a group of users are bid on by advertisers. For example, only a single offer for a steakhouse may be active at one time within a geographic area. The various steakhouses may then bid on the opportunity to provide an active offer to a plurality of users. The bidding may specify a willingness to share a percent of the total transaction upon the user utilizing an offer. Other payment methods are possible. The offer sales component 248 may provide a listing of offers presently available to advertisers and help them tailor an offer that is likely to garner interest. The offer sales component 248 may be a gatekeeper that maintains offers fitting parameters that ensure they are likely to be used by above a threshold percentage of consumers.

The subscriber data store 250 tracks profile data for subscribers or users of the offer service. The subscriber data store 250 can include a user's credit card data and other data gathered upon signing up. The subscriber data store 250 may track a user's purchases, offer subscriptions, offer rejections, and other data related to the user's interaction with offers.

The subscriber processing component 252 may build and assign personas using the audience data and a machine-learning algorithm A persona is an abstraction of a person or groups of people that describes preferences or characteristics about the person or groups of people. The personas may be based on media content the persons have viewed or listened to, as well as other personal information stored in a user profile on the user device (e.g., game console) and associated with the person. For example, the persona could define a person as a female between the ages of 20 and 25 having an interest in science fiction, movies, and sports. Similarly, a person who shows interest in cars may be assigned a persona of “car enthusiast.” More than one persona may be assigned to an individual or group of individuals. For example, a family of five may have a group persona of “animated film enthusiasts” and “football enthusiasts.” Within the family, a child may be assigned a persona of “likes video games,” while the child's mother may be assigned a person of “dislikes video games.” It will be understood that the examples provided herein are merely exemplary. Any number or type of personas may be assigned to a person.

The subscriber interface component 254 provides an interface through which the subscriber or user may view active offers associated with their credit cards and express preferences and rules governing autolinking of offers. The offers may be delineated by subject matter, location, specific vendors, and other factors. For example, the user may request not to be linked to offers for coffee shops. The preferences may identify specific advertisers the user wants to express a preference for linking or prohibition for linking. The preferences may also specify categories of products and services that are of interest to a user. The subscriber interface component 254 may provide a privacy component that allows a user to opt in or opt out of sharing any type of information. The user may also be given the opportunity to opt in or opt out of the use of any information available to the offer service 240.

The incentive management component 256 manages incentives provided to users who share an offer invitation. The incentive management component 256 can track the recipients who receive an offer invitation and each recipient's response to the offer invitation. Responses can include viewing, forwarding, clicking to receive a customized offer, subscribing to a customized offer, and making a purchase using the offer. Different incentives can be provided for sharing different offers. Incentives can also be based on the response. Incentives can be cumulative. For example, a user that shares ten offers may receive an incentive, such as access to a previously unavailable offer. The incentive could be reward points, achievements in a game service, recognition, or similar.

The incentive management component 256 can identify successful sharers based on the response to her offer invitation. Merchants may be given the opportunity to provide special incentives to highly ranked sharers for sharing the merchant's offer invitation.

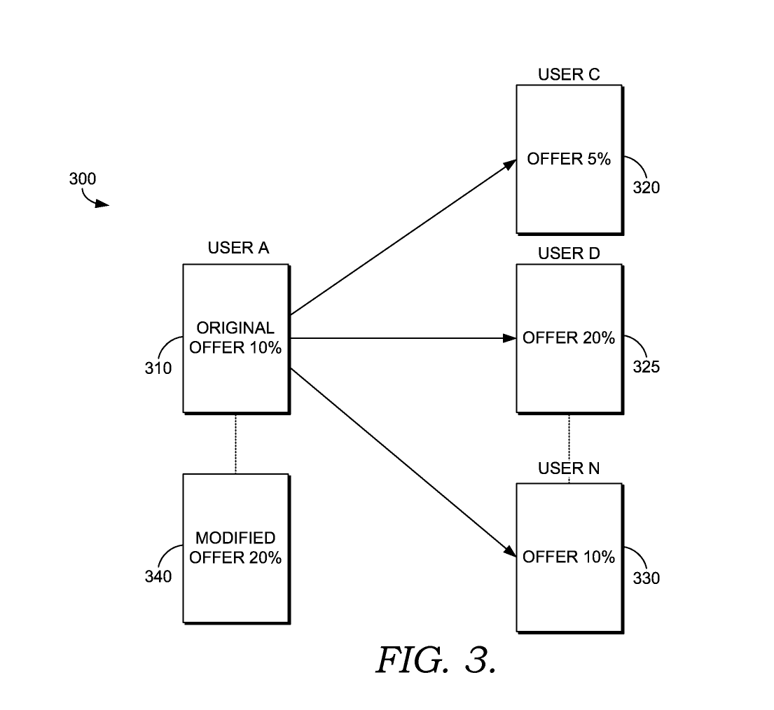

Turning now to FIG. 3, customized offers and an incentive to share offer invitations are illustrated, in accordance with an aspect of the present invention. Initially, user A has received original offer 310. Original offer 310 provides a 10% discount on a product or service offered by a merchant. User A communicates an offer invitation to users C, D, and N. Aspects of the invention are not limited to sharing offer invitations with three users or any particular number of users.

The offer service may provide an incentive for users to communicate offer invitations to their friends. For the act of sharing offer invitations, offer 310 has been replaced with modified offer 340. Modified offer 340 provides a 20% discount on a good or service offered by the merchant. Thus, user A is able to increase his discount from 10% to 20% by sharing offer invitations with others. Further incentives could be applied depending on the response to the offer invitations.

In one aspect, the incentives are provided to encourage selective sharing to people likely to have an interest in a particular product, service, or merchant. Selective sharing is in contrast to sharing with all or most of the user's contacts. An example of selective sharing is emailing an offer invitation for discounted baseball tickets to three friends with a known interest in baseball. An example of nonselective sharing is emailing the same discounted baseball ticket offer invitation to a user's entire mailing list.

Selective sharing may be encouraged by different incentive regimes. For example, in one aspect, users are not incentivized to share an offer invitation with beyond a threshold number of users. For example, the user may receive incremental incentives for sharing an offer invitation with up to 10 users but received no additional incentive for sharing with more than 10 users. An incremental incentive provides an additional value each time an offer invitation is shared. For example, a user may receive an additional dollar off a product or service for sharing with up to 10 users for a maximum of $10 off.

In addition to limited incremental incentives, a sharing incentive may be reduced or taken away entirely based on a poor response to the offer invitation. For example, the sharing incentive may be provisional and only awarded upon recipients of the offer invitation responding positively. A positive response can comprise viewing or clicking on an offer invitation in addition to subscribing to an offer. Tying incentives to viewing and clicking records also acts as a fraud deterrent.

A sharing incentive can be based on a positive response percentage to an offer invitation. For example, a greater incentive could be given to a user for achieving a 90% positive response rate from 10 recipients than is given to a user for achieving a 9% positive response rate from 100 recipients. Using a positive response percentage rate encourages selective sharing by reducing incentives when a low percentage positive response is achieved.

Available incentives provided by the offer sharing service can be adjusted on a user-by-user basis based on a cumulative sharing record. A cumulative sharing record is based, at least in part, on recipient responses to a plurality of offer invitations. In one aspect, a user with a poor cumulative sharing record may be notified that she is not eligible for any future sharing incentive. Conversely, users with a positive cumulative sharing record may receive further incentives for sharing. The offer sharing service may make a user's cumulative sharing record available to him or her along with a rank or grade indicating whether the user is making wise sharing decisions.

As can be seen, each of the recipients (C, D, and N) received an offer having a customized incentive. The customized incentive can be determined based on characteristics of the user. Characteristics of the user can include a user's interests, purchase history, offer history, and demographic information. The user may receive his customized offer by accessing the offer sharing service in response to the offer invitation. The offer sharing service may be accessed by following a link within the invitation or through other means. Before receiving an offer, the user may need to register with the offer service. A user may need to provide demographic information when registering the offer service. As mentioned, the offer service may use card-linked offers, which are linked to a user's credit card and require use of the card to realize the offer. In this case, the user would have to register with the service and register one or more credit cards in order to subscribe to an offer.

User C received offer 320, which provides a 5% discount on a good or service offered by the merchant. The good or service involved in offer 320 may differ from the good or service involved in the other offers. Generally, the merchant is the same across all of the offers shown in FIG. 3. As mentioned, a user may communicate an offer invitation in response to receiving an offer. The offer invitation provides some description of the type of offer that may be available to the user, but may avoid specifics to leave room for offer customization. For example, the offer invitation may explain that a discount is available on women's shoes offered by a particular merchant. Each user that responds to the offer invitation may receive a customized offer that has a different discount that could be applied to different types of shoes.

User D receives offer 325, which provides a 20% discount. Notice that both offer 320 and offer 325 provide customized discounts that are different from the original 10% discount in offer 310. In other words, a recipient of an offer invitation could receive a customized offer that is either greater than or smaller than the offer extended to the individual sharing the offer invitation.

User N receives offer 330, which provides a 10% discount. This illustrates that the original offer 310 in a recipient's customized offer 330 can be the same. Offers are likely to be the same when the sharer and the recipient share common characteristics.

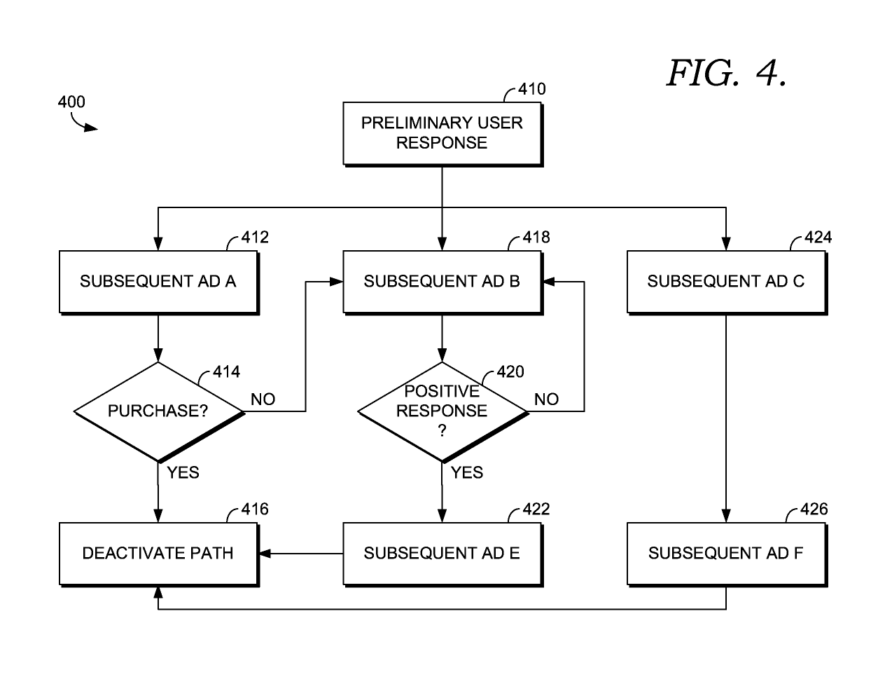

Turning now to FIG. 4, a nonlinear offer path 400 is shown, in accordance with an aspect of the present invention. As can be seen above in FIG. 3, individual users can receive customized offers based on their characteristics. Nonlinear offer path 400 can be used to select an offer (or offer incentives) that is appropriate for a particular user. The offer path 400 illustrates the use of offer history to adjust future offers. As used herein, “offer history” is a history of a user's interactions or lack of interactions with an offer. An offer interaction can include subscribing to an offer, rejecting an offer, making a purchase using a subscribe-to offer, and the like.

The offer path 400 starts with a preliminary user response 410 to an offer, such as utilizing a preliminary offer to make a purchase. Different subsequent offers within the offer path 400 may be offered in response to the preliminary user response 410. The preliminary user response 410 may be explicit or implicit.

For example, the user could respond positively by showing interest in an offer for tickets to a baseball game between two teams. Upon determining that the user is associated with a city where one of the teams is based, the user could be placed into an offer path designed to incentivize the user to purchase goods or services associated with the baseball team. For example, subsequent offer A 412, could be related to the user purchasing tickets for a baseball game. At decision point 414, the user's response to subsequent offer A 412 is evaluated. Upon determining that the user purchased baseball tickets, the path may be deactivated at step 416. Once deactivated, the user could be entered at the beginning of the path, but no further progression in the path is possible. The user's purchase record may be updated indicating that the user purchased baseball tickets, confirming the user's interest in this baseball team.

Upon determining that the user did not purchase baseball tickets in response to subsequent offer A 412, the user may be moved to a different part in the offer path 400 associated with subsequent offer B 418. Because offer A 412 was not effective for whatever reason, offer B 418 could provide a different incentive. For example, offer A 412 could be for a discount on box seats, while offer B 418 is a discounted family package. The user can be moved to a different point in a path each time a user responds or fails to respond to an offer invitation. Additionally, offers can be made to the user apart from the user responding to an offer invitation.

The response to subsequent offer B 418 is monitored at decision point 420. Upon determining that a positive response has not been received, the offer B 418 may remain active or may be deactivated. If a positive response is noted at decision point 420, then the user could be moved to a different part in the path associated with subsequent offer E 422 the next time an offer is extended. Though not shown, the various points along the path could loop or be deactivated in response to a purchase, offer subscription, or the like.

In one aspect, the part of the path showing subsequent offer C 424 and subsequent offer F 426 are related to a complimentary product, such as a baseball jersey or cap. Thus, while the part of the path associated with subsequent offers 412, 418, and 422 are all attempting to sell baseball tickets, the complimentary products may be part of a related subsequent path with different vendors and incentives.

The user could be offered or subscribed-to multiple subsequent offers within the offer path 400 at the same time when appropriate. For example, the user could be subscribed to a subsequent offer for baseball tickets at the same time she is associated with a subsequent offer for baseball caps. Similarly, the user could be offered multiple subsequent offers for the same thing but with different incentives. For example, the user criteria could specify different geographic locations associated with different retail stores and different incentives offered by those respective stores. Or the user could be offered a discount on both box seats and a family seat package at the same time.

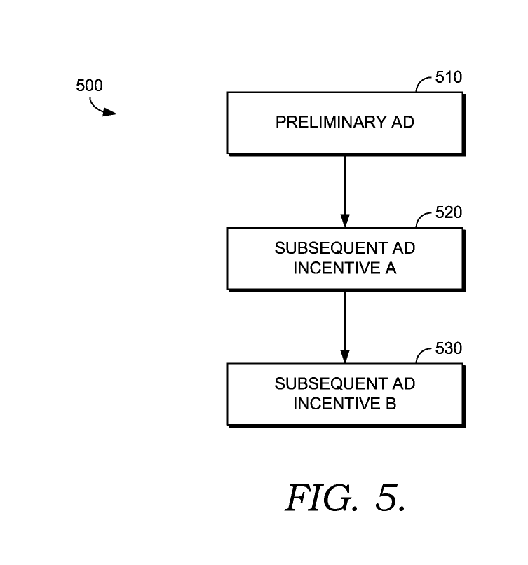

Turning now to FIG. 5, a linear offer path 500 is shown, in accordance with an aspect of the present invention. The linear offer path 500 can be used to select customized incentives based on the user's characteristics. The linear path 500 is simpler than offer path 400 and illustrates a progression of offers. The linear offer path 500 includes a preliminary offer 510, a subsequent offer 520 having incentive A, and a subsequent offer 530 having incentive B. Incentives A and B are different.

The preliminary offer 510 may be offered to users that have not previously done business with the merchant associated with the offer. The preliminary offer 510 may have other eligibility criteria. The preliminary offer 510 has reaction criteria. Satisfaction of the reaction criteria trigger need to be met before the next offer in the offer path 500 can be extended to the user. The reaction criteria are related to the user's reaction to the preliminary offer 510. For example, the user may utilize the offer, manually unsubscribe to the offer, or ignore the offer under a variety of different circumstances. For example, a user ignoring an offer while not being in proximity to the merchant can be a different reaction from ignoring the offer while driving by the merchant five times after subscribing to the offer. Once the reaction criteria are satisfied, the subsequent offer 520 can be offered to the user. The subsequent offer 520 may be different from the preliminary offer 510.

The subsequent offer 520 may be shown to the user multiple times across multiple devices. In each case, the presentation and response, if any, may be communicated to a centralized offer tracking service. At some point, the user's response, or lack of response, to the subsequent offer 520 may cause the user to be shifted down the offer path 500 to subsequent offer 530 having incentive B. In one aspect, the failure of the user to respond to the subsequent offer 520 with incentive A causes the user to be shifted down the offer path 500 to subsequent offer 530 with incentive B, which is higher than incentive A. In other situations, incentive A and incentive B are not of a significantly different value, but are just different. For example, incentive A could be for the user to get a discounted soft drink, while incentive B is for the user to get a discounted cup of coffee.

In one aspect, the user's positive response to subsequent offer 520 causes the user to be shifted to subsequent offer 530 that promotes a related product or service from the same vendor. In this case, incentives A and B would be directed toward different products associated with their corresponding offers. For example, having purchased movie tickets using subsequent offer 520, subsequent offer 530, having a coupon for popcorn, is offered to the user.

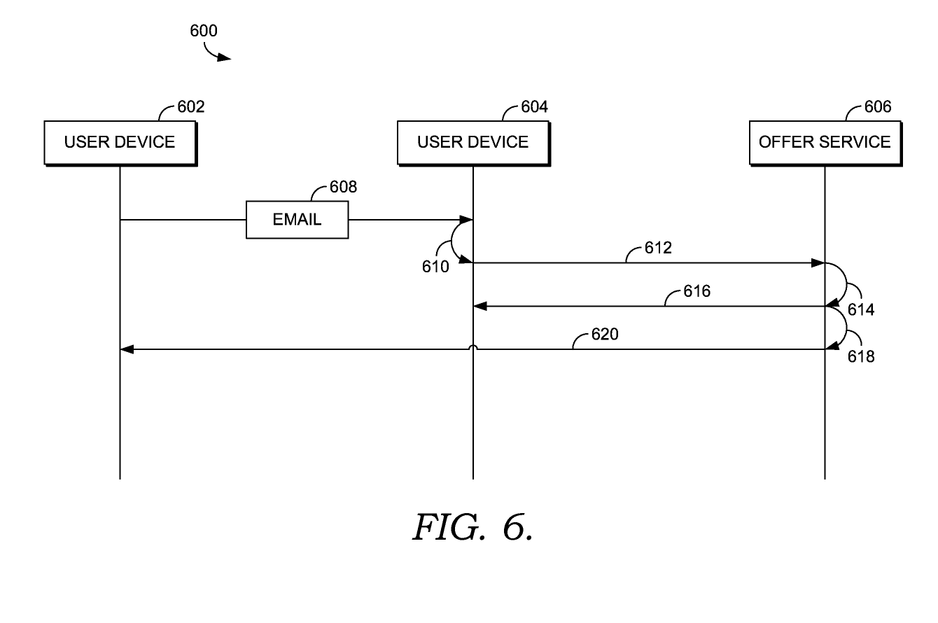

Turning now to FIG. 6, communications exchanged during the communication of an offer invitation are illustrated, in accordance with an aspect of the present invention. The communications environment 600 comprises user device 602, user device 604, and offer service 606. The user devices can be smartphones, tablets, personal computers, and the like. The offer service 606 may operate in a data center comprising multiple computer devices or multiple data centers. The communications may pass over a wide area network, such as the Internet.

Initially, user device 602 communicates an offer invitation 608 via email to user device 604. In this example, user device 602 and user device 604 are associated with different users. User device 602 is associated with an individual sharing an offer invitation and user device 604 is associated with a user receiving an offer invitation. The email is shown going directly between the two devices for the sake of simplicity, but in reality multiple intermediate devices may actually be used to communicate the email message. For example, both user devices may access a web-based email service to send and/or receive email messages.

The recipient of offer invitation 608, through user device 604, seeks 610 additional offer details. The invitation may provide a link through which the user seeks 610 the additional details. The request 612 for additional details is communicated to the offer service. The offer service generates 614 a customized offer for the recipient. The details 616 of the customized offer are communicated back to user device 604 and the associated recipient. In this case, the recipient takes no further action, and therefore does not subscribe to the offer. Were the user to subscribe to the offer, an additional communication can be sent from user device 604 to the offer service 606, which may in turn provide a confirmation to user device 604.

The offer service 606 calculates 618 an incentive for the user of user device 602. The incentive may be automatically applied to the user's account by the offer service 606. An explanation of the incentive 620 is communicated to user device 602. The explanation may simply confirm that the incentive is available on the user's account. Additional information, such as the user's cumulative sharing record may be included within the explanation. Further incentives that may be realized based on a recipient's response to the sharing may also be explained within the incentive explanation.

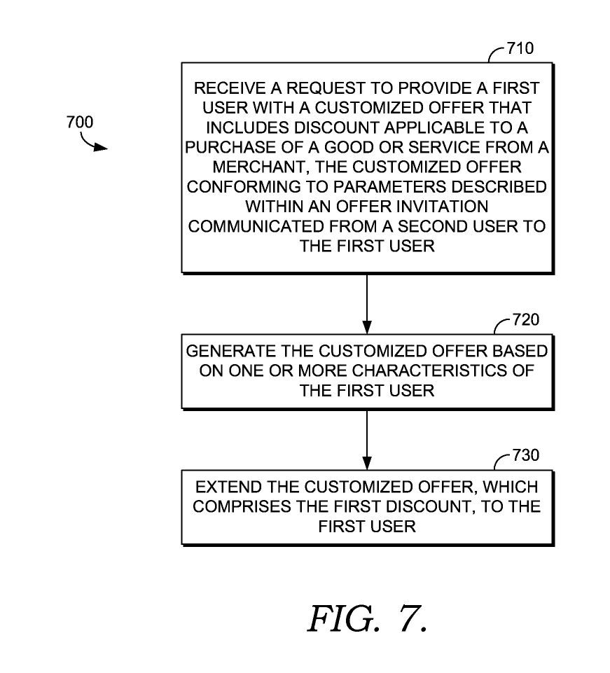

Turning now to FIG. 7, a method 700 for providing customized offers is shown, in accordance with an aspect of the present invention. Method 700 may be performed by an offer service, such as offer service 240 described previously.

At step 710, a request is received to provide a first user with a customized offer to purchase a good or service from a merchant. The customized offer conforms with parameters described within an offer invitation communicated from a second user to the first user. For example, the offer invitation may state that a discount on shoes is available for a particular merchant. The customized offer will then offer a specific discount on all shoes, or a subset of shoes, offered for sale by the merchant.

The term “request” is to be construed broadly. The request of step 710 may comprise a response to the user clicking on a link within the offer invitation. The request may comprise the user navigating to a website associated with an offer service. The request may be an email, text, or other communication directed to an offer service. The request may originate from an offer application installed on the first user's computing device. The offer application may allow the user to perform various functions related to the offer service, including receiving and responding to offer invitations.

At step 720, the customized offer is generated based on one or more characteristics of the first user. The customized offer may be generated by selecting one of several available offers by matching the user characteristics with corresponding eligibility criteria for each offer. When a user satisfies the criteria for multiple available offers, a separate selection criteria may be used to determine which offer is favored by a merchant or requested by a recipient. Both merchants and recipients may specify offer preferences that are used to determine eligibility for an offer and select an offer when eligibility requirements are met.

Exemplary eligibility requirements may include previously transacting business with a merchant. For example, a loyalty offer may only be available to users who have previously done business with a merchant. A user's geographic proximity to a merchant is another example of an eligibility requirement. Demographic characteristics may also be used to determine eligibility for an offer. For example, a restaurant may require recipients of a happy hour promotion to be over the age of 21.

At step 730, the customized offer is extended to the first user. The customized offer comprises a first discount. The discount may be in the form of a rebate or other value transferred to a user who makes a purchase consistent with the customized offer. The discount may also be a reduction in a price paid for a good or service specified within the customized offer. In one aspect, the offer is a card-linked offer to which the user is able to subscribe.

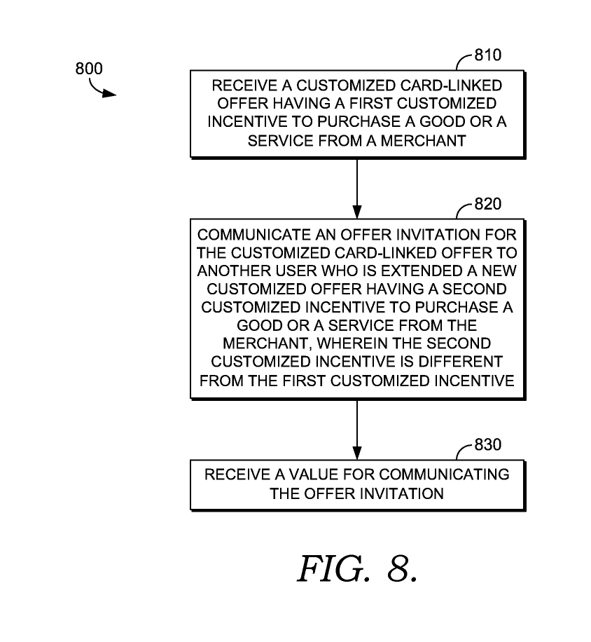

Turning now to FIG. 8, a method 800 for providing card-linked offers is provided, in accordance with an aspect of the present invention. Method 800 can be performed by a user of an offer service, by a client application that facilitates the offer service, and the like.

At step 810, a customized card-linked offer having a first customized incentive to purchase a good or a service from a merchant is received. At step 820, an offer invitation for the customized card-linked offer is communicated to another user who is, in turn, extended a new customized offer having a second customized incentive to purchase a good or service from the merchant. The second customized incentive is different from the first customized incentive. For example, the first customized incentive may be a 10% discount and the second customized incentive can be a 20% discount. The offer invitation may be communicated via a social network, email, text message, and the like. The offer invitation may comprise communicating an offer, an offer notification, or a specific offer invitation. For example, a user that receives an offer invitation may communicate the offer invitation to another user. A user that subscribes to a customized offer can communicate a confirmation notification, which can serve as an offer invitation, to others.

In one aspect, an offer service generates communications that can serve multiple purposes, at least one of which is as an offer invitation. For example, an offer notification may explain details of an offer available to a first user along with an explanation that others may be eligible for an offer having different incentives and instructing a recipient how to receive a customized offer or to determine eligibility for a customized offer. The offer service may interface with social networks and allow the user to automatically generate offer invitations within one or more of their social networks.

At step 830, a value is received for communicating the offer invitation. The volume may be based on a means through which the offer invitation was communicated. For example, a greater incentive may be provided when an offer invitation is selectively communicated through a social network than when the offer invitation is communicated through email. Recipient response to the offer invitation may also be used to determine a value. In one aspect, multiple values are determined based on multiple available incentives. For example, a first value may be provided for sharing the offer invitation and a second value calculated based on a recipient's response to the invitation.

Aspects of the invention have been described to be illustrative rather than restrictive. It will be understood that certain features and subcombinations are of utility and may be employed without reference to other features and subcombinations. This is contemplated by and is within the scope of the claims.

The invention claimed is:

1. One or more computer-storage media having computer-executable instructions embodied thereon that when executed by a computing device perform a method for providing customized offers, the method comprising:
receiving a request to provide a first user with a customized offer that includes a discount applicable to a purchase of a good or service from a merchant, the customized offer conforming to parameters described within an offer invitation communicated from a second user to the first user;
generating the customized offer based on one or more characteristics of the first user, the customized offer having a first discount; and
extending the customized offer, which comprises the first discount, to the first user.

2. The media of claim 1, wherein the method further comprises receiving an instruction to subscribe the first user to the customized offer.

3. The media of claim 2, wherein the customized offer is a card-linked offer that is linked to the first user's account upon receiving the instruction.

4. The media of claim 1, wherein the method further comprises providing a value to the second user for sharing the offer invitation.

5. The media of claim 4, wherein the method further comprises determining the value based on a sharing mechanism used for sharing the offer invitation.

6. The media of claim 4, wherein the value is based on the first user's response to the offer invitation.

7. The media of claim 4, wherein the request identifies the offer invitation in a way that the offer invitation can be attributed to the second user who shared the offer invitation with the first user.

8. The media of claim 1, wherein the user characteristics comprise whether or not the first user has previously purchased a good or a service from the merchant.

9. A method of providing customized card-linked offers, the method comprising:
receiving a customized card-linked offer having a first customized incentive to purchase a good or a service from a merchant;
communicating an offer invitation for the customized card-linked offer to another user who is extended a new customized offer having a second customized incentive to purchase a good or a service from the merchant, wherein the second customized incentive is different from the first customized incentive;
receiving a value for communicating the offer invitation.

10. The method of claim 9, wherein the value is based on an amount of people that received the offer invitation.

11. The method of claim 9, wherein the value is based on a recipient's response to the offer invitation.

12. The method of claim 9, wherein the value is based on the medium used to share the offer invitation.

13. The method of claim 9, wherein the first customized incentive and the second customized incentive apply to different products sold by the merchant.

14. The method of claim 9, wherein the second customized incentive selected is based on the other user's transaction history with the merchant.

15. A computerized system having a processor and computer memory with computer-executable instructions for managing an offer service, the system comprising:
an incentive component that assigns an incentive to a user to reward the user for communicating an offer invitation to one or more other users; and
an offer customization component that builds a customized offer for a recipient of the offer invitation by matching a user's characteristics with merchant business rules that specify characteristics for eligibility to receive the customized offer,
wherein the user sharing the offer invitation is extended a different offer from the offer extended to the recipient of the offer invitation.

16. The system of claim 15, wherein different users receiving the offer invitation receive different offers from the offer customization component.

17. The system of claim 15, further comprising a social graph analysis component that monitors offer invitations shared within a social network.

18. The system of claim 15, further comprising an offer linking component that links an offer to a user's credit card upon the user subscribing to the offer.

19. The system of claim 15, wherein the offer invitation comprises an offer notification forwarded via email from the user.

20. The system of claim 15, wherein the offer invitation comprises a link to access an interface that the ad customization component uses to communicate offer details.
